(19) United States
(12) Patent Application Publication
(10) Pub. No.: US 2023/0038466 A1
(43) Pub. Date: Feb. 9, 2023

(54) SINGLE METHOD FOR BLOCKING ACCESS THREATS USING VIRTUALIZATION TECHNOLOGY IN CLIENT-SERVER APPLICATIONS

(71) Applicant: SURENDRA KUMAR TULSYAN, Cary, NC (US)

(72) Inventor: SURENDRA KUMAR TULSYAN, Cary, NC (US)

(21) Appl. No.: 17/396,778

(22) Filed: Aug. 9, 2021

(51) Int. Cl. H04L 9/40

(52) U.S. Cl. CPC H04L 63/0876; H04L 63/0823; H04L 63/168; H04L 63/0435; H04L 63/1416

(57) ABSTRACT

A method for providing a software based secure, robust, flexible, usable, and auditable single method that can practically eliminate threat occurring from phishing, man-in-middle theft, pharming/channel redirection, piggybacking of spyware, and application modification in client applications. These can be very strongly achieved using dynamic virtualization technology. This virtualization technology entirely protects applications from such threats is by creating highly dynamic virtual images of real data that are private, relative, one-time use, and short-lived. These virtual images are strongly made private and relative by creating virtual device id of the client device, virtual application signature of the client application, virtual private network of the network and virtual certificate of the server.

### FIELD OF THE INVENTION

The present invention relates to the client application security

### Description

### BACKGROUND OF THE INVENTION

Very strong detection of access threats from client applications can be achieved using virtualization technology.

Most client applications requiring user authentication and optionally device authentication. Client applications are highly vulnerable from various threats. The most common method of protecting threats commonly known as two-factor-authentication (2FA), verification of app signature (typically a checksum value) can be either nullified or bypassed.

Some of these Common Threats are:

a) Application Programming Interface—API exploitation
Most client applications communicate to server using Application Programming Interface (“API”). APIs are typically HTTP or HTTPS calls. Client application send data to server as payload with API call. The server merely processes payload data based on what it has received. The server can't understand and guarantee authenticity of consuming application, authenticity of source, and authenticity of data. If data, source, and/or application is managed at client side then there is zero security. This short-coming can be used to exploiting APIs to carry-out fraudulent transactions by manipulating payload.

b) Rogue App
Many applications are written in languages like Java, C#, javascript and they are compiled as byte code. These applications can be easily decompiled. This decompiled code can be modified to carry-out fraudulent transactions, then distributed to users. Typically, this modified application is distributed to users using messages with download link on social media, email, SMS, etc. Even if part of code is written in native language like C++, the compiled code can be de-assembled, modified, and assembled back.
Typically, in client application, anti-tampering code is introduced which calculates checksum value of some objects. This value is checked against the database to confirm integrity of application. In a modified application checksum value/hash value of original application can be substituted in the modified app to fool the integrity check.

c) Phishing
Phishing is the fraudulent attempt to obtain sensitive information such as usernames, passwords, device id, app signature, application data (e,g. application checksum value, SSL certificate, encryption keys, etc.) and business data (e,g. credit card data, bank account information, etc.) by disguising oneself as a trustworthy entity in an electronic communication. Mostly a look alike or similar client application is presented to user with branding of the original app to deceive user to obtain sensitive information like authentication data, application data, and/or business data.
In a case of Web based transactions, mostly a look alike page is presented to user to capture the required data.
Many applications are written in languages like Java, C# and they are compiled as byte code. These applications can be easily decompiled. This decompiled code can be modified to steal required data, then distributed to user. Even if part of code is written in native language like C++, the compiled code a de-assembled, modified, and assembled back. Similarly, in web-based applications data can be stolen using browser extensions.

d) Man-In-Middle Attack
Typically using some frameworks running of client device, communication to host computers can be trapped. This data can be further used for carrying out fraudulent transactions. Similar man-in-middle attempts can be made at the network level if unsecured protocol is used.

e) Pharming/Channel Redirection
In a modified app, all communications indented fora specific computer can be redirected to some other computers. On other computer this data can be modified before submitting to the specific computer. Thus, stolen data can be used for carrying out frau du lent transactions.

f) Piggybacking of Spyware
Spyware code can be introduced as part of application code. On installation of this application with spyware code, spyware is hiddenly installed on the user's client device. Spyware can capture and transmit sensitive data like contact information, telephone calls, SMS, emails, social media messages, audio, video, data files, etc.

g) SSL Certificate Stealing
SSL certificates are hard-coded in application code. By reverse engineering application code these certificates can be stolen. These stolen certificates can be further used for carrying out frau du lent transactions.

h) Encryption Key Stealing
Encryption keys are hard-coded in application code. Typically, applications use symmetric encryption like AES or DES. By reverse engineering application code these keys can be stolen. These stolen keys can be further used for decrypting stolen data, modifying it and re-encrypting before carrying out fraudulent transactions.

What is needed is a system and process having features—
a) Pro-actively identification of these threats,
b) Instantly warn user,
c) Instantly block or nullify threats,
d) User friendly without additional any explicit action,
e) Uniquely identify the affected device
f) Dynamic encryption of threat data so that phishing, man-in-middle attack and channel redirection become useless.
g) Strongly authenticate all factors
h) A software running on one or many security servers that accepts input encrypted data; generates the encryption key based on dynamic/static stored/exchanged data, decrypts the encrypted data based on the encryption key, evaluates the static factors against its database, and evaluates the dynamic factors based on pre-defined logic,
i) Allowing or denying the access to the host based on the authentication results and threat detection results.

### SUMMARY OF INVENTION

The present invention discloses a secure, robust, flexible, usable, and auditable single method that can practically eliminate threat occurring from phishing, man-in-middle theft, pharming/channel redirection, piggy-backing of spyware, and app modification in client-based applications.

These can be very strongly achieved using dynamic virtualization technology. Virtualization technology entirely protects applications from mentioned threats by creating highly dynamic virtual images of real data that are private, relative, one-time use, and short-lived.

This is achieved by installing as security component in client application.

In case of mobile applications or desktop/laptop based applications this security component can be implemented as an application plug-in. In case of browsers, it can be implemented as browser extension.

The present invention is implemented using a client installed software with security component and corresponding server software. The client installed software component residing as either as an independent application or part of client application running on the user's client, dynamically generates client time-based encryption keys. These dynamically generated keys are used for encrypting static/dynamic gathered factors, virtual device id, device data, virtual certificates, virtual application signature, virtual network data, threat data, application data, business data, and tracking data. This dynamically generated encrypted data referred as virtual image that has a very limited life and one-time use. Thus, virtual images of data are highly dynamic and changing all the time, as time is the most dynamic factor. This client installed software creates a virtual device id of the user's client device based on private and relative properties of static objects of application and/or client. Virtual device id can't be phished and can't be substituted. This client installed software generates virtual application signature by creating inter-dependent chain of internal, private, and relative properties of the client application. A dynamic virtual private network between the user's client device and the server software is created by adding network id of path the transaction is supposed to take as part of real data. This virtual private network does not require pre-binding of IP addresses between user's client device and the server software. Similarly, virtual certificate between the user's client device and the server software is created by adding certificate value of the server software of as part of real data, ensuring strong trusting between the client application and the server software.

The present invention is implemented using corresponding server based de-virtualization and authentication engine software. This software is referred as security server Software. Client application sends dynamically generated virtual image to the security server Software over network using a network communication method. On receipt of this data the security server Software generates the corresponding encryption keys and applies to received virtual image to get the clear-text data. The engine further validates passed factors based on a pre-determined logic and/or against factors stored in its database.

The present invention is implemented by developing client application component and core engine in native language like C, C++, etc. It is practically improbable to decompile and understand the full logic of large native language compile code.

The implementation of current invention can vary depending on client device OS, client device OS version and user permissions.

As will be appreciated, the method and system disclosed herein are capable of other and different embodiments, and capable of modifications in various respects. Accordingly, the drawings and description set forth herein are to be regarded as illustrative in nature and not restrictive.

### BRIEF DESCRIPTION OF THE DRAWINGS

FIG. 1 represents a block diagram indicating user using a client device communicating with security server over a network.

FIG. 2 represents a block diagram indicating initializing of communication and handshaking between the user client device and the security server.

FIG. 3 represents a block diagram indicating generation of virtual image of data, submission of virtualized data to security server, and further processing of submitted data.

### DETAILED DESCRIPTION OF A PREFERRED EMBODIMENT

As will be appreciated that a user's client device that runs a client application is a computer only.

As will be appreciated that a client application is set of computer programs typically performing some intendent activities. This application may require user authentication for a successful login and/or for a successful transaction.

As will be appreciated by one skilled in the art, aspects of the present inventions may be embodied as a system, method, or computer program product. Accordingly, aspects of the present inventions take the form of an entirely software embodiment (including firmware, resident software, micro-code, etc.). Furthermore, aspects of the present inventions may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fibre, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fibre cable, RF, etc., or any suitable combination of the foregoing.

Computer program code for carrying out operations for aspects of the present inventions may be written in any combination of one or more programming languages, including an object-oriented programming language such as Java, Smalltalk, C++, or the like and conventional procedural programming languages, such as the “C” programming language or similar programming languages. The program code may execute entirely on the users client device, partly on the user's client device, as a stand-alone software package, partly on the user's client device and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Two computers and or two devices communicate to each other over LAN or WAN using some network communication protocols like HTTP, HTTPS, etc.

Aspects of the present inventions are described below with reference to flowchart illustrations and/or block diagrams of methods, apparatus (systems) and computer program products according to embodiments of the inventions. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions that execute on the computer or other programmable apparatus provide processes for implementing the functions/acts specified in the flowchart and/or block diagram block or blocks.

The present invention is a method and system that can be implemented using single solution that can detect and block all access threats in the client application and multi-factor authentication in the client application-initiated transactions using virtualization technology.

The present invention is a method and system that can be implemented either an independent client application with security component or adding component in an existing client application. It does not require any specialized hardware or software to run.

The present invention is a method and system that extends authentication process for commonly used authentication—user-id and password.

The present invention is a method and system that may require users to install a new application or updated an existing version of client application having security component.

The present invention is a method and system that requires security server to install virtualization and authentication engine component software on host computers. security server includes one or many computers with at least one processor and a memory storing one or more executable instructions and data.

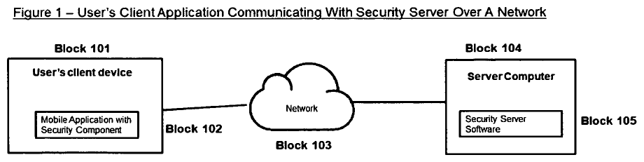

With reference now to the figures and in particular to FIGS. 1, 2 and 3, exemplary diagrams of data processing environments are provided in which illustrative embodiments may be implemented. It should be appreciated that FIGS. 1, 2, and 3 are only exemplary and are not intended to assert or imply any limitation with regard to the environments in which different embodiments may be implemented. Many modifications to the depicted environments may be made.

The flowcharts and block diagrams in the figures illustrate the architecture, functionality, and operation of possible implementations of systems, methods and computer program products according to various embodiments of the present inventions. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

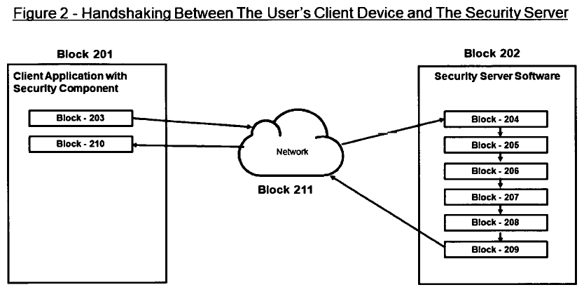

FIG. 1, FIG. 2, and FIG. 2 show block diagrams of system defined in the present invention.

FIG. 1 represents a block diagram indicating user using a client application communicating with security server over a network.

FIG. 1 Block 101—indicates the user's client device. Client devices typically run popular OS like Android, iOS, Windows, Linux, Mac, Windows Phone, etc. They have a built-in Random Access Memory (RAM), CPU, Storage devices (ROM), Network cards, and other associated software. These devices are connected to the internet or the intranet using one or many of Wi-Fi, cellular network, Ethernet Card, USB, dial-up modem, etc.

FIG. 1 Block 102—indicates the client application installed on the user's client device. To carry out any transaction, typically user installs an application on the client device. This application provides the user interface, can do processing, store data, and communicate to the computers over the network.

FIG. 1 Block 103—indicates network. It can be LAN or WAN.

FIG. 1 Block 104—indicates the server computer. This computer can run on typical operating systems like Windows, Linux, Unix, Mac, etc. This computer has built-in Random Access Memory (RAM), CPU, Storage devices (ROM) like DISK, USB, etc., Network cards, databases, and other associated software.

FIG. 1 Block 105—indicates the installed security server software. This software has pre-defined logic. The instructions of this software run under CPU and accesses/stores data either in RAM or ROM. This software can communicate to network.

FIG. 2 represents a block diagram indicating initializing of communication and handshaking between the user client device and the security server.

FIG. 2 Block 201—indicates the application with security component installed on the user's client device connected to network

FIG. 2 Block 202—indicates the installed security server software on host computer connected to network

FIG. 2 Block 203—demonstrates a process typically initiated at the start of application or at a later stage in application program. This process sends a handshake request to the security server.

FIG. 2 Block 204—demonstrates a process where on receipt of a request initiated in [0045], the security server assigns a Request Id to request. Request Id can be random number.

FIG. 2 Block 205—demonstrates a process where on receipt of the request initiated in [0046], the security server calculates Network Id and assigns it to the request. Network Id can be derived from public IP request of the sender.

B=fx1 (IP address)
Where B is calculated Network Id; fx1—is a custom function

FIG. 2 Block 206—demonstrates a process where on receipt of the request initiated in [0046], the security server calculates the Time Factor based on a dynamic factor like the server time or a random number and assigns it to the request.

C=fx2 (host server time or a random number)
Where C is Time Factor; fx2—is a custom function

FIG. 2 Block 207—demonstrates a process where on receipt of the request initiated in [0046], the security server assigns Certificate Value based on pre-assigned unique value identifying security server to the request.

D=fx3 (pre-assigned unique value)
Where D is Certificate Value; fx3—is a custom function

FIG. 2 Block 208—demonstrates a process where the security server stores Request Id calculated in [0047], Time Factor calculated in FIG. [0049] the security server current time are stored either in RAM or ROM.

FIG. 2 Block 209—demonstrates a process where the security server sends Request Id, Network Id, Time Factor, and Certificate Value calculated in [0047], [0048], [0049] and [0050] respectively as part of the response to client application.

FIG. 2 Block 210—demonstrates a process where client application receives the response from the security server and stores them either in instant variables of native language developed security component.

FIG. 2 Block 211—indicates network. It can be LAN or WAN.

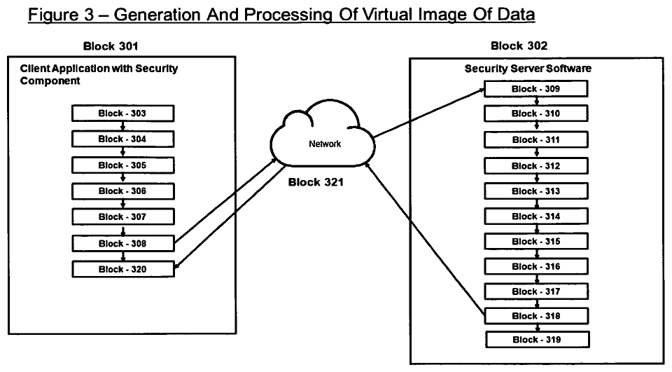

FIG. 3 represents a block diagram indicating generation of virtualization data, submission of virtualization data to security server, and further processing of submitted data.

FIG. 3 Block 301—indicates the application with security component installed on the user's client device connected to network.

FIG. 3 Block 302—indicates the installed security server software on host computer connected to network.

FIG. 3 Block 303—demonstrates a process where the user wants to submit a transaction from the client application. The transaction can be login or any other application transaction (like fund transfer, payment, message sending, purchase, etc.)

FIG. 3 Block 304—demonstrates a process which on initiating transaction in [0058] either read or calculates Virtual Device Id based on file properties (like file creation time, name, size) and stores in an instant variable of security plug-in.

E=fx4 (file properties)
Where E is calculated Virtual Device Id; fx4—is a custom function
Since the Virtual Device Id generated from multiple properties using a custom function and stored in an instant variable of security plug-in, it is practically impossible for anyone to get the value of the generated Virtual Device Id. Since no OS permits changing of file creation time, phished Device Id value can't be substituted or managed by changing file creation time.

FIG. 3 Block 305—demonstrates a process which on initiating transaction in [0058] creates Virtual Application Signature which is based on chain of related, inter-dependent properties of internal objects of client application. One or many chains can be created from these properties.

### N1=fx5(p1)

Where p1 is property of object; N1—Node of chain; fx5—is a custom function

### N2=fx6(p2,N1)

Where p2 is property of object; N1—Node of chain; N2—Node of chain; fx6—is a custom function

### N3=fx7(p3,N2)

Where p3 is property of object; N2—Node of chain; N3—Node of chain; fx7—is a custom function

### N4=fx8(p4,N3)

Where p4 is property of object; N3—Node of chain; N4—Node of chain; fx8—is a custom function
Using above demonstrated method a chain of large number of nodes can be created. Similarly, multiple chains can be created.

### F=fx9(N1, N2, N3, N4, . . . )

Where F is Virtual Application Signature value; fx9—is a custom function, N1, N2, N3, N4, . . . —Nodes of chain
This created Virtual Application Signature is stored in an instant variable of security plug-in.
Since the Virtual Application Signature generated from multiple internal properties using a custom function and stored in an instant variable of security plug-in, it is impossible for anyone to get the value of the generated Virtual Application Signature. Similarly, it is practically impossible to substitute the value of Virtual Application Signature in the instance variable.
These chains of Virtual Application Signatures are cross checked. Any mismatch or deviation indicates tampering. On detection of tampering can shutdown application.

FIG. 3 Block 306—demonstrates a process which on initiating transaction in [0058], dynamically creates Encryption Key which is derived from device time. At the same time a relative Time Offset is calculated using the device time, with base as Time Factor calculated in [0049].

G=fx10 (current time on client device)
Where G is encryption key; fx10—is a custom function
H=fx11 (current time on client device, Time Factor)
Where H is Time Offset; fx11—is a custom function
Since the encryption key generated using a custom function and stored in an instant variable of security component, it is impossible for anyone to get the value of the generated encryption key. Since Time Offset is based on current time of user's client device and Time Factor which is derived from server time, the combination of generated key and Time Offset will be unique with a very high probability and will be highly dynamic.
It becomes practically impossible for one to guess or steal such dynamic encryption key. Similarly, it is impossible for someone to arrive at encryption key just from Time Offset.
It is nearly impossible for a third person or device or computer to know the exact time of the user's client device when transaction was initiated.

FIG. 3 Block 307—demonstrates a process where Virtual Device Id generated in [0059], Virtual Application Signature generated in [0060], Certificate Value from instance variable as in [0050], and Network Id from instance variable as in [0048], along with other important application data and important business data are compiled together. This compiled real data is encrypted using Encryption Key generated in [0061] giving dynamically encrypted Virtual Image. Both encryption key and Time Factor are destroyed within the program. Hence, they are not available to anyone—person or computer.

FIG. 3 Block 308—demonstrates a process where Virtual Image generated in [0062] along with Time Offset calculated in [0061] and Request Id as in [0047] are sent to the security server.

FIG. 3 Block 309—demonstrates a process where the security server receives the Virtual Image along with Time Offset data send in [0063].

FIG. 3 Block 310—demonstrates a process where the security server based on the received Request Id send in [0063] fetches Time Factor, and Server Time from stored data described in [0051].

FIG. 3 Block 311—demonstrates a process where the security server based on the fetched Time Factor in [0065], and using a complementary method described in [0061] re-calculates the encryption key.

I=fx12 (Time Factor, Server Time, Time Offset)
Where I is device time at transaction initiation on client application; fx12—is a custom function
J=fx13 (device time)
Where J is calculated encryption key; fx13—is a custom function
Successful decryption of the Virtual Image generated in [0062], with the generated encryption key gives the real data. Unsuccessful decryption indicates data tampering. On unsuccessful decryption the transaction is rejected.

FIG. 3 Block 312—demonstrates a process where the security server fetches the Network Id from the obtained real data in method [0066], generates Network Id using logic of method [0048] and compares the fetched Network Id with the generated Network Id.

A successful matching indicates that the data was generated from the originating network only. On unsuccessful matching the transaction is rejected.
Thus, this process demonstrates creation of dynamic Virtual Private Network between the user's client device and the security server. The process does not require any pre-binding of IP addresses.

FIG. 3 Block 313—demonstrates a process where the security server fetches the Certificate Value from the obtained real data in method [0066], generates Certificate Value using logic of method [0050] and then compares the fetched Certificate Value with the generated Certificate Value.

A successful matching indicates that the generated virtual image was submitted to the right server. On unsuccessful matching the transaction is rejected.
Thus, this process demonstrates creation of Virtual Certificate enabling strong trusting between the user's client device and the security server. The process does not require pre-issue and/or installation of any certificate.

FIG. 3 Block 314—demonstrates a process where the security server fetches the Virtual Application Signature from the obtained real data in method [0066], and compares it with the pre-activated Virtual Application Signature stored in ROM of the security server.

A successful matching indicates that the client application is not tampered. On unsuccessful matching the transaction is rejected.

FIG. 3 Block 315—demonstrates a process where the security server fetches the Virtual Device Id from the obtained real data in method [0066] and compares it with the pre-registered Virtual Device Id stored in ROM of the security server.

A successful authentication of device indicates that the requested is coming from already registered device. On unsuccessful matching the transaction is rejected.

FIG. 3 Block 316—demonstrates a process where all transaction logs are maintained on the security server for each request identified by Request Id. Re-submission of the same transaction more than one time rejects the transaction, if a log of the Request Id is found.

FIG. 3 Block 317—demonstrates a process where a list of all requests identified by Request Id and corresponding server time. The security server rejects the request if the elapsed time between the server time at the time of Request Id generation and transaction receipt time is beyond the allowed window.

FIG. 3 Block 318—demonstrates a process where passed application data and business data are obtained from the real data and they are available to server for further processing.

FIG. 3 Block 319—demonstrates a process where methods [0047] to are repeated. Request Id, Network Id, Time Factor, and Certificate Value along with result of checks defined in [0066] to [0072] are returned as a response to the user's client application.

FIG. 3 Block 320—demonstrates a process where the user's client application receives the response from security server and stores them in instance variables. Based on the transaction result, it either rejects the transaction or accepts the transaction for further processing.

FIG. 3 Block 321—indicates network. It can be LAN or WAN.

Thus, the present invention demonstrates a single software that protects transactions from all access threats and also provide strong authentication of the device, the network, the application, and the server.

Thus, the present invention requires minimum software to be deployed on the user's client device. It does not require any special hardware.

Thus, the present invention allows creation of dynamic virtual images of real data by encrypting data using a factor derived from device time with a varying base. It is practically impossible for a third person or third computer to know the exact time on the user client device and the base at the time of transaction initiation. Without knowing the encryption key, it is not practically possible to decrypt the encrypted data and extract the real data in seconds.

Thus, the present invention creates a very strong anti-tampering check by dynamic generation of the application signature, which is based on multiple relative internal properties of the application objects. Multiple inter-dependent chains can be made from these internal properties of application objects. To break the signature all properties and relations, they have to be dynamically modified at run-time. Thus, it is not practically possible or highly improbable.

Thus, the present invention allows the dynamic generation of device id that either not derived from any steal able property of device or can't be presented without dynamic cracking of client application at run-time. Stealing of the value of instance variable of a native compiled code requires taking memory dump of client device. Memory dumping may switch off the device or may take a long time. It is not practical to read huge memory dump and extract the required data in seconds. Thus, stealing is not practically possible. Similarly, to compromise device id either device has to be injected in instance variable by dynamic cracking of security component or file creation date has to be changed. Both are technically not possible.

Thus, the present invention provides very strong protection against phishing and usage of phished data. As it is virtually impossible to decrypt data encrypted using factor derived from device time, all data required for carrying out successful transaction can't be phished.

Thus, the present invention creates a dynamic virtual private network between the user's client device and the security server. Thus, any data stolen using man-in-middle attack or pharming/channel redirection can't be submitted from any other device or computer, as the public IP address of this other device or computer won't match with the public IP address of the user's client device. Thus, this invention does not require any pre-binding of IP addresses to establish VPN.

Thus, the present invention provides a very strong protection against a man-in-middle at the user's client device level. The stolen data has to be submitted within few seconds and before the actual data is submitted to the security server. This has to be done without modifying the application. This is technologically impossible.

Thus, the present invention provides a very strong protection against encryption key stealing. This is because client component does not share any key in the process. Also, stealing of dynamic encryption keys with a very short life makes stealing practically impossible and useless.

Thus, the present invention provides a very strong protection against stealing of SSL certificate and/or SSL certificate bypassing. Since this invention creates its own certificate which can't be stolen, the stealing of SSL certificate or bypassing of SSL certificate become useless. This invention achieves strong trusting between the users client device and the security server.

Thus, the present invention creates a virtual image that is private to the user's client device, private to the client application, private to the network, and private to the server.

Thus, the present invention creates a virtual image that is relative to the user's client device time and relative to the server time. It is nearly impossible to detect and break these relations.

Thus, the present invention creates a virtual image of data that has very short life. This can be achieved because virtual images are based on time.

Thus, the present invention creates a virtual image of data that is one time use. This can be achieved by maintaining usage log of each image.

Thus, the present invention provides a very strong protection against spyware piggybacking. For spyware piggybacking the client application has to be modified, which violates Virtual Application Signature. Thus, making spyware piggybacking useless.

Thus, the present invention provides a very strong protection of application data and business data against any kind of theft. This is because these data are always sent to server as part of virtual image and the real application data and the real business data are available at server level only. Thus, neither they can be stolen or injected any level without going through the virtualization process. To inject at client application level, the application has to be modified. Any modification breaks the application signature and thus rejecting the transaction.

Thus, the present invention provides a very strong protection against API exploitation. This is achieved by binding payload to the client application, the client device, the network, and the server. The required payload can't be created without going through dynamic virtual image processing, but that requires changes in client application. Any change violates application signature validation thus rejecting the transaction.

Thus, the present invention can be implemented as an application plug-in in mobile based applications or desktop/laptop-based applications, depending on OS support. Similarly, it can be implemented as a browser extension for web-based solution depending on the browser support to browser extensions technology.

Thus, the present invention does not require any change in the user interface.

Thus, the present invention defines a process where the security server software running on host computers accepts the encrypted data; generates the encryption key, decrypts the encrypted data using the generated encryption key, evaluates the static factors against its stored data in ROM, and evaluates the dynamic factors based on pre-defined logic. Since the stored factors on ROM and pre-defined logic is available only with the security server, no security server other than the target security server can process transaction successfully.

Thus, the present invention defines a process that based on the threat evaluation and the authentication results, the host computer has total ability of allowing or denying the access.

I claim:

1. A method of authenticating the identity of a device, network, server, and the application to get secure access to server resources, comprising: providing a generated virtual image based on multiple factor data instances; evaluating factor-based data instances to determine if the identities are authenticated; restricting the user's access to the server resources if identities are not positively authenticated; and granting the user's access to the server resources if all identities are positively authenticated.

2. The method of claim 1 wherein threat evaluation and multi-factor authentication requires a simple client component as part of client application running on the user's client. The client component can be implemented as an application plug-in in mobile based applications or desktop/laptop-based applications, depending on OS support. Similarly, it can be implemented as a browser extension for web-based solution depending on the browser support to browser extensions technology.

3. The method of claim 1 that is implemented using server component that carries out evaluation of Identities.

4. The method of claim 1, comprising of the client component that is distributed as compiled object. It is written in native language like C++/C, thus making de-compilation of large compiled code practically impossible. It is practically very difficult to understand compiled native language code without modifying and dynamically testing multiple times.

5. The method of claim 1, comprising of component that creates application signature based on internal properties of application components and creates one or many inter-dependent relative chains of these properties. These properties and these chains are evaluated by the component code to check the tampering of application. Any modification of any object breaks the whole chain. Thus, it is practically impossible to tamper the application.

6. The method of claim 1, comprising of component that dynamically generates device id based on properties of file properties and custom logic. This device id is not externally available; hence it can't be phished. Similarly, the device id can't be fraudulently generated by changing any external property.

7. The method of claim 1, comprising of a process that strongly protects against phishing of all data required for carrying out successful transaction.

8. The method of claim 1, comprising of a process that allows to build strong dynamic virtual private network between the user's client device and the security server. Thus, any data stolen using man-in-middle attack and/or pharming/channel redirection can't be used from any other device.

9. The method of claim 1, comprising of a process that allows to create a certificate which can be trusted by issuing security server. This gives strong protection against SSL certificate stealing and/or SSL certificate bypassing.

10. The method of claim 1, comprising of a process that strongly protects against stealing encryption keys. Since component dynamically generates device time-based encryption keys, it is nearly impossible to steal them and use them to decrypt data.

11. The method of claim 1, comprising of a process that strongly protects against spyware piggybacking. As for piggybacking the application has to be modified. Any modification to application rejects the transaction.

12. The method of claim 1, further comprising of a process where the dynamically generated encrypted image of data is relative to the user's client device time and relative to the server time. Time being the most dynamic factors, it becomes practically impossible to detect and break these relations.

13. The method of claim 1, further comprising of a process where the dynamically generated encrypted image of data is private to the user's client device, private to the client application, private to the network, and private to the server. Thus, it becomes impossible to steal these images and reuse them from any other device other than the originating device, over any other network other than the originating network, by any other application other than the original application, and with any other server than the intendent server.

14. The method of claim 1, further comprising of a process where the dynamically generated encrypted image of data keeps changing at extremely high frequency, reducing the chances of theft to practically zero.

15. The method of claim 1, further comprising of a process where the life of image is very short, in the order of few seconds and the image is one-time use.

16. The method of claim 1, further comprising of a process where dynamic virtual images required for successful authentication are relative, one-time use, and short-lived. All these make virtually impossible to steal and re-use them for carrying of successful transaction using stolen data.

17. The method of claim 1, further comprising of a process where a very strong protection against API exploitation can be achieved. This is achieved by binding payload to the client application, the client device, the network, and the server. The required payload can't be created with out going through dynamic virtual image processing, but that requires changes in client application. Any change violates application signature validation thus rejecting the transaction.

18. The method of claim 1, further comprising of a process where security server software running on server computers that accepts the virtual image of data; generates the encryption key, decrypts the virtual image based on the generated encryption key, evaluates the static factors against its database, and evaluates the dynamic factors based on pre-defined logic.

19. The method of claim 1, further comprising of a process where application data and business data are sent to server as a part of the dynamic virtual image and they are available only at the server level. Thus, neither they can be stolen or injected any level.

20. The method of claim 1, further comprising of a process where security server has total ability of allowing or denying accesses based on the authentication results.
